(19) United States
(12) Patent Application Publication
(10) Pub. No.: US 2025/0326478 A1
(43) Pub. Date: Oct. 23, 2025

(54) DOOR MECHANISM AND METHOD OF OPENING A TRANSLATING DOOR

(71) Applicant: The Boeing Company, Arlington, VA (US)

(72) Inventor: Michael T. Mortland, Mukilteo, WA (US)

(21) Appl. No.: 18/639,789

(22) Filed: Apr. 18, 2024

(51) Int. Cl. B64C 1/14; E05D 15/28

(52) U.S. Cl. CPC B64C 1/1407; E05D 15/28; E05Y 2900/502; E05Y 2900/531

(57) ABSTRACT

A door mechanism has an arm configured to be coupled to a side of a door opening in a body at an arm-body interface having an arm-body hinge axis about which the arm rotates. In addition, the door mechanism has an arm-door interface located on an end of the arm opposite the arm-body interface and which is configured to couple the arm to a door having a door lower portion and a door upper portion. The arm-door interface comprises an arm-door upper joint and an arm-door lower joint located below and inboard of the arm-door upper joint when the door is in a closed position. The arm-door lower joint is configured to pivot about the arm-door upper joint in a manner pivoting the door lower portion in an outboard direction to a greater extent than the door upper portion during translation of the door from the closed position to an open position.

### FIELD

The present disclosure relates generally to door hinges and, more particularly, to a door mechanism configured to maintain a door generally parallel to a door opening while translating the door from a closed position to an open position.

### BACKGROUND

Large commercial aircraft typically have an inflatable escape slide mounted to each passenger entry door (i.e., emergency egress door) to provide a means for rapid evacuation of the aircraft in the event of an emergency. Each escape slide is housed within a slide bustle mounted to the inside of the emergency egress door. Certain aircraft such as narrow body aircraft are increasingly designed with emergency egress doors that accommodate longer escape slides. Longer escape slides are necessary because newer narrow body aircraft are higher off the ground to accommodate newer jet engines that are larger in diameter.

Emergency egress doors with larger escape slides require door mechanisms having longer hinge arms capable of moving the door clear of the door opening in the fuselage. More specifically, a longer hinge arm can position the open door further from the fuselage to provide additional space for the larger escape slide. Unfortunately, a longer hinge arm adds weight to the aircraft. In addition, a longer hinge arm reduces the width of the small window that is typically located next to the hinge arm to allow the flight crew to observe conditions outside of the aircraft before opening the emergency egress door.

As can be seen, there exists a need in the art for a door mechanism for an aircraft emergency egress door that accommodates a larger escape slide without requiring an increase in the length of the hinge arm.

### SUMMARY

The above-noted needs associated with door mechanisms are addressed by the present disclosure, which provides a door mechanism comprising an arm and an arm-door interface. The arm is configured to be coupled to a side of a door opening in a body at an arm-body interface having an arm-body hinge axis about which the arm rotates. The arm-door interface is located on an end of the arm opposite the arm-body interface and is configured to couple the arm to a door having a door lower portion and a door upper portion. The arm-door interface comprises an arm-door upper joint and an arm-door lower joint. The arm-door lower joint is located below and inboard of the arm-door upper joint when the door is in a closed position, and is configured to pivot about the arm-door upper joint in a manner pivoting the door lower portion in an outboard direction to a greater extent than the door upper portion during translation of the door from the closed position to an open position.

Also disclosed is an aircraft having a fuselage. The fuselage has a door opening and an emergency egress door having a door lower portion and a door upper portion. In addition, the aircraft has a door mechanism coupling the emergency egress door to the fuselage. The door mechanism comprises an arm and an arm-door interface. The arm is coupled to a side of the door opening at an arm-body interface having an arm-body hinge axis about which the arm rotates. The arm-door interface is located on an end of the arm opposite the arm-body interface and couples the arm to the emergency egress door. The arm-door interface comprises an arm-door upper joint and an arm-door lower joint. The arm-door lower joint is located below and inboard of the arm-door upper joint when the emergency egress door is in a closed position, and is configured to pivot about the arm-door upper joint in a manner pivoting the door lower portion in an outboard direction to a greater extent than the door upper portion during translation of the emergency egress door from the closed position to an open position.

Also disclosed is a method of opening a door. The method includes rotating an arm about an arm-body hinge axis at an arm-body interface coupling the arm to a side of a door opening in a body. In addition, the arm is coupled to a door at an arm-door interface located on an end of the arm opposite the arm-body interface. The arm-door interface has an arm-door hinge axis extending between an arm-door upper joint and an arm-door lower joint located below and inboard of the arm-door upper joint when the door is in a closed position. The method additionally includes rotating the door about the arm-door hinge axis in a direction opposite to, and during, rotation of the arm about the arm-body hinge axis in a manner maintaining the door generally parallel to the door opening. The method also includes pivoting, during rotation of the door, the arm-door lower joint about the arm-door upper joint in a manner causing a door lower portion to move in an outboard direction to a greater extent than a door upper portion when the door moves from the closed position to an open position.

The features, functions, and advantages that have been discussed can be achieved independently in various versions of the disclosure or may be combined in yet other versions, further details of which can be seen with reference to the following description and drawings.

### BRIEF DESCRIPTION OF THE DRAWINGS

The disclosure can be better understood with reference to the following detailed description taken in conjunction with the accompanying drawings, which illustrate preferred and exemplary versions, but which are not necessarily drawn to scale. The drawings are examples and not meant as limitations on the description or the claims.

FIG. 1 is a top view of an example of an aircraft having multiple passenger entry doors (i.e., emergency egress doors), each of which is in an open position and each of which has an inflatable escape slide deployed from a door lower portion of the emergency egress door;

FIG. 2 is a side view of the aircraft of FIG. 1;

FIG. 3 is a magnified view of one of the emergency egress doors of FIG. 2 showing an escape slide in the deployed configuration;

FIG. 4 is an outboard-looking perspective view of an example of an emergency egress door in a closed position and which is supported by the presently-disclosed door mechanism;

FIG. 5 is a magnified view of the door mechanism of FIG. 4 showing an arm coupled to a side of the door opening at an arm-body interface having an arm-body hinge axis, and showing the arm coupled to the emergency egress door at an arm-door interface;

FIG. 6 is an end view of the emergency egress door and the door mechanism taken along line 6-6 of FIG. 5;

FIG. 7 is an aft-looking perspective view of the door mechanism of FIG. 6 showing the arm coupled to the door opening at the arm-body interface;

FIG. 8 is a forward-looking perspective view of the door mechanism of FIG. 6 showing the arm coupled to the emergency egress door at the arm-door interface via an arm-door upper joint and an arm-door lower joint located below and inboard of the arm-door upper joint when the emergency egress door is in the closed position;

FIG. 9 is a bottom-up perspective view of the door mechanism showing the arm-door lower joint;

FIG. 10 is a flowchart of a method of opening a door using the presently-disclosed door mechanism;

FIG. 11 is an outboard-looking perspective view of an emergency egress door in the closed position;

FIG. 12 is an end view of the emergency egress door of FIG. 11;

FIG. 13 is a magnified view of the door mechanism when the emergency egress door is in the closed position as shown in FIGS. 11-12;

FIG. 14 is a bottom-up view of the door mechanism taken along line 14-14 of FIG. 13;

FIG. 15 is an outboard-looking perspective view of the emergency egress door after initial movement of the emergency egress door to a lifted position prior to translation of the emergency egress door to the open position;

FIG. 16 is an end view of the emergency egress door of FIG. 15;

FIG. 17 is a magnified view of the door mechanism when the emergency egress door is in the lifted position as shown in FIGS. 15-16;

FIG. 18 is a bottom-up view of the door mechanism taken along line 18-18 of FIG. 17;

FIG. 19 is an outboard-looking perspective view of the emergency egress door after rotating the arm 45 degrees about the body-arm hinge axis during translation of the emergency egress door toward the open position;

FIG. 20 is an end view of the emergency egress door of FIG. 19;

FIG. 21 is a magnified view of the door mechanism of FIG. 20;

FIG. 22 is a bottom-up view of the door mechanism taken along line 22-22 of FIG. 21;

FIG. 23 is an outboard-looking perspective view of the emergency egress door after rotating the arm 90 degrees about the body-arm hinge axis during translation of the emergency egress door;

FIG. 24 is an end view of the emergency egress door of FIG. 23;

FIG. 25 is a magnified view of the door mechanism of FIG. 24;

FIG. 26 is a bottom-up view of the door mechanism taken along line 26-26 of FIG. 25;

FIG. 27 is an outboard-looking perspective view of the emergency egress door after rotating the arm 135 degrees about the body-arm hinge axis to place the emergency egress door in the open position;

FIG. 28 is an end view of the emergency egress door of FIG. 27;

FIG. 29 is a magnified view of the door mechanism of FIG. 28;

FIG. 30 is a bottom-up view of the door mechanism taken along line 30-30 of FIG. 29;

FIG. 31 is an inboard-looking perspective view of the emergency egress door in the open position;

FIG. 32 is an aft-looking perspective view of the emergency egress door in the open position;

FIG. 33 is an end view of the emergency egress door in the open position showing the gap between the fuselage and the slide bustle, which houses the escape slide;

FIG. 34 is an outboard-looking perspective view of the emergency egress door in an overlifted position;

FIG. 35 is an end view of the emergency egress door of FIG. 34 in the overlifted position;

FIG. 36 is a magnified view of the door mechanism when the emergency egress door is in the overlifted position as shown in FIGS. 34-35;

FIG. 37 is a bottom-up view of the door mechanism taken along line 37-37 of FIG. 36.

The figures shown in this disclosure represent various aspects of the versions presented, and only differences will be discussed in detail.

### DETAILED DESCRIPTION

Disclosed versions will now be described more fully hereinafter with reference to the accompanying drawings, in which some, but not all of the disclosed versions are shown. Indeed, several different versions may be provided and should not be construed as limited to the versions set forth herein. Rather, these versions are provided so that this disclosure will be thorough and fully convey the scope of the disclosure to those skilled in the art.

This specification includes references to “one version” or “a version.” Instances of the phrases “one version” or “a version” do not necessarily refer to the same version. Similarly, this specification includes references to “one example” or “an example.” Instances of the phrases “one example” or “an example” do not necessarily refer to the same example. Particular features, structures, or characteristics may be combined in any suitable manner consistent with this disclosure.

As used herein, “comprising” is an open-ended term, and as used in the claims, this term does not foreclose additional structures or steps.

As used herein, “configured to” means various parts or components may be described or claimed as “configured to” perform a task or tasks. In such contexts, “configured to” is used to connote structure by indicating that the parts or components include structure that performs those task or tasks during operation. As such, the parts or components can be said to be configured to perform the task even when the specified part or component is not currently operational (e.g., is not on).

As used herein, an element or step recited in the singular and preceded by the word “a” or “an” should be understood as not necessarily excluding the plural of the elements or steps. As used herein, the term “and/or” includes any and all combinations of one or more of the associated listed items. As also used herein, the term “combinations thereof” includes combinations having at least one of the associated listed items, wherein the combination can further include additional, like non-listed items.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

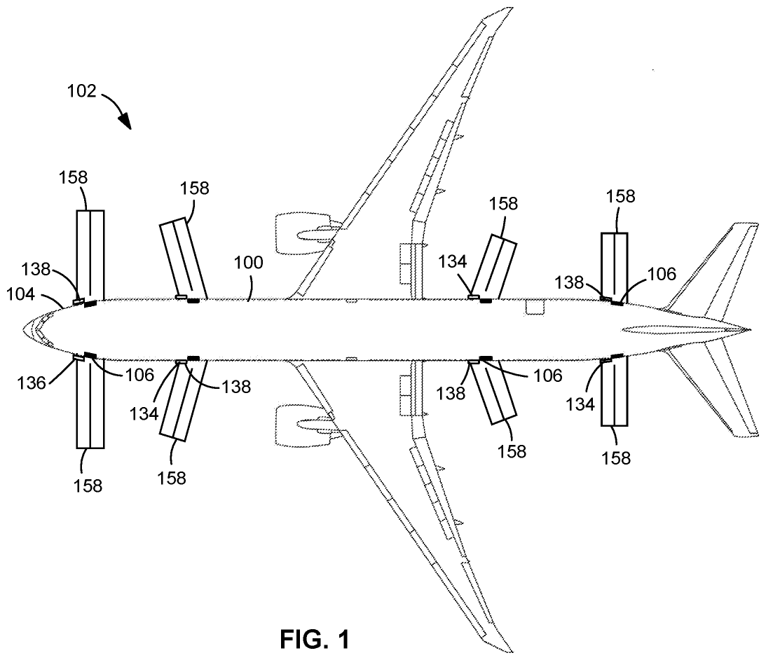

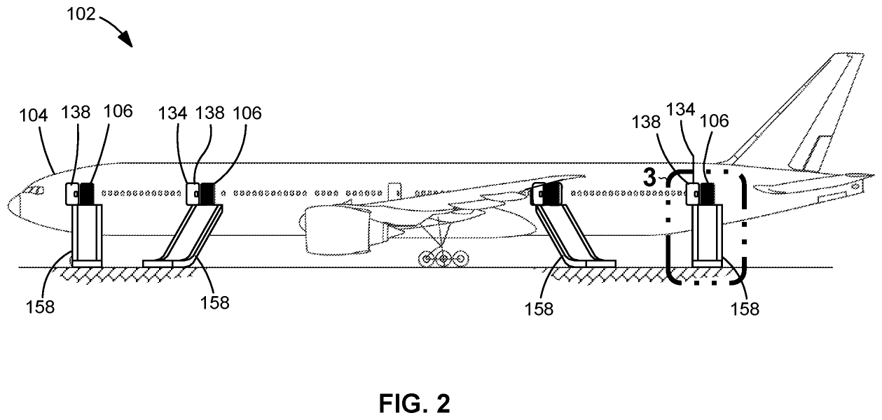

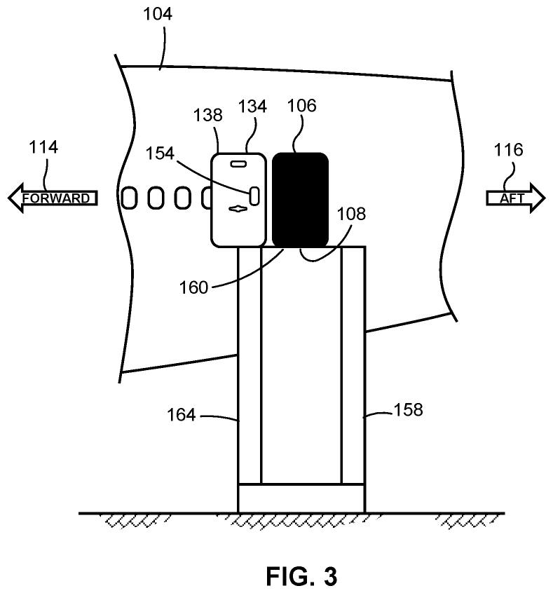

Referring now to the drawings which illustrate various examples of the disclosure, shown in FIGS. 1-2 is an example of an aircraft 102 having a fuselage 104 with multiple door openings 106 and a passenger entry door for each door opening 106. Each passenger entry door shown in the open position 134 in FIGS. 1-2 is an emergency egress door 138 having an inflatable escape slide 158 deployed from the emergency egress door 138. FIG. 3 is a magnified view of a portion of the aircraft 102 of FIG. 2 showing one of the emergency egress doors 138 in the open position 134 and showing an example of an escape slide 158 in the deployed configuration 164. The escape slide 158 has a slide upper portion 160 that is attached to a door sill 108 at the bottom of the door opening 106.

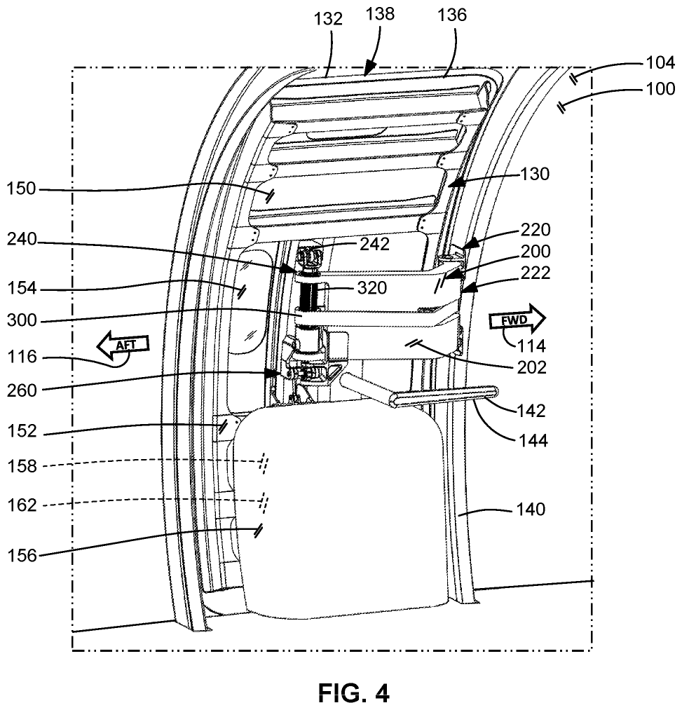

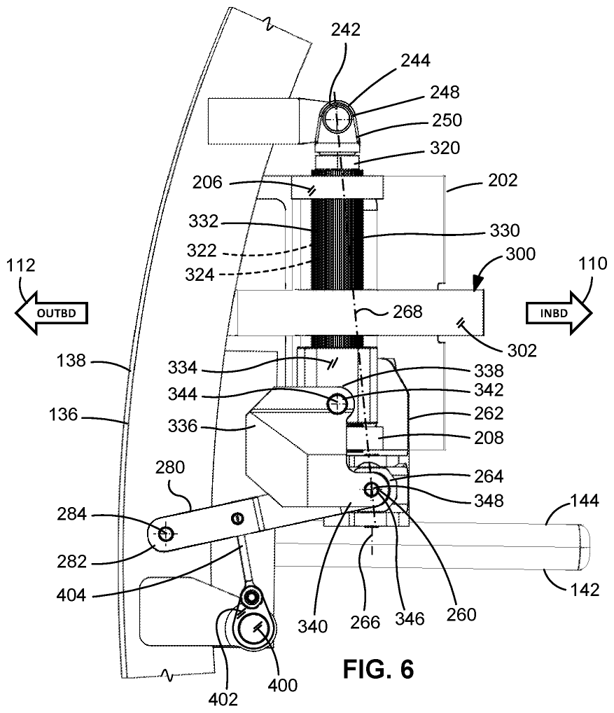

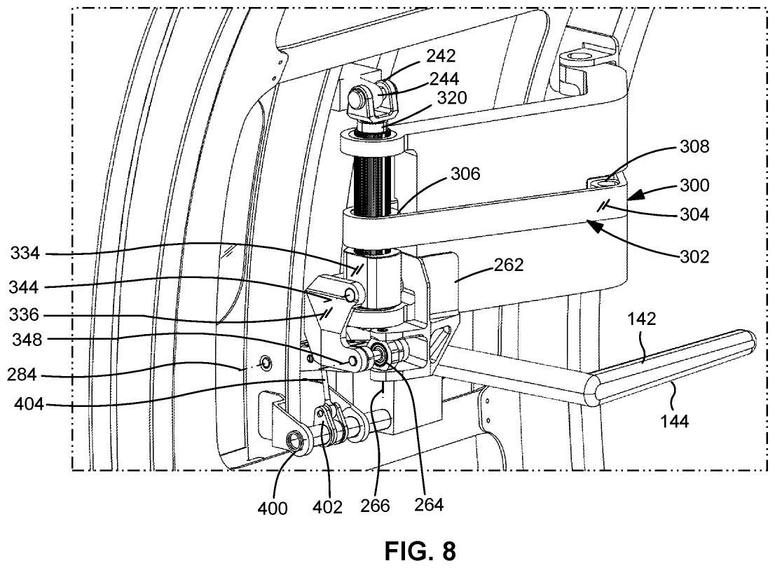

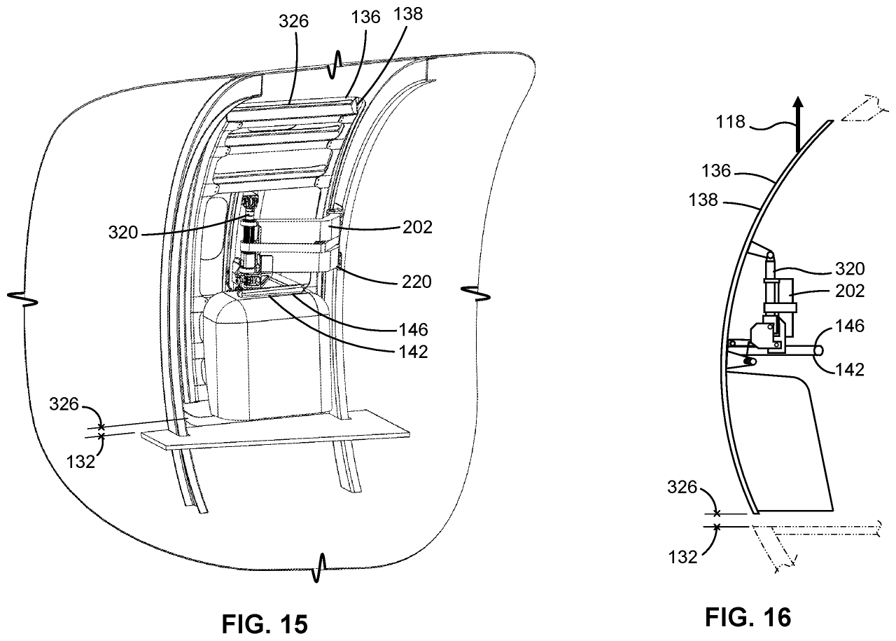

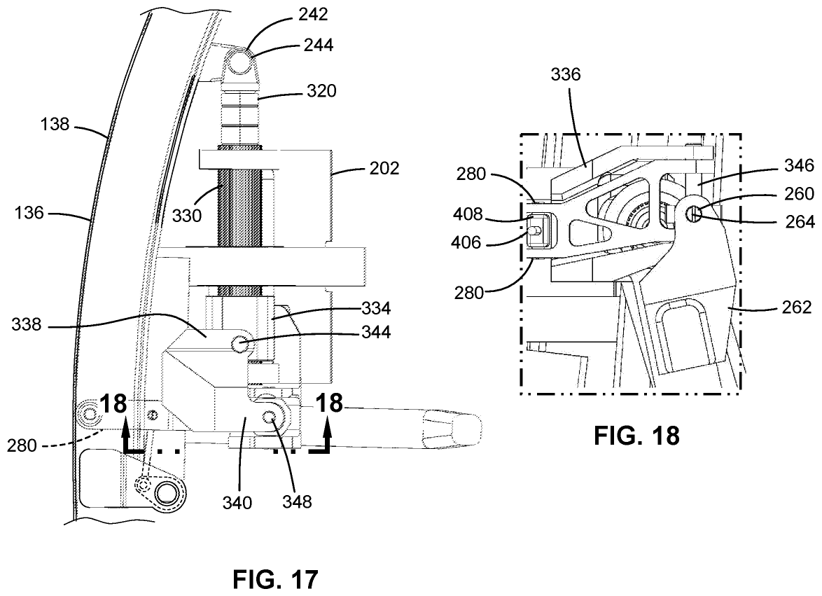

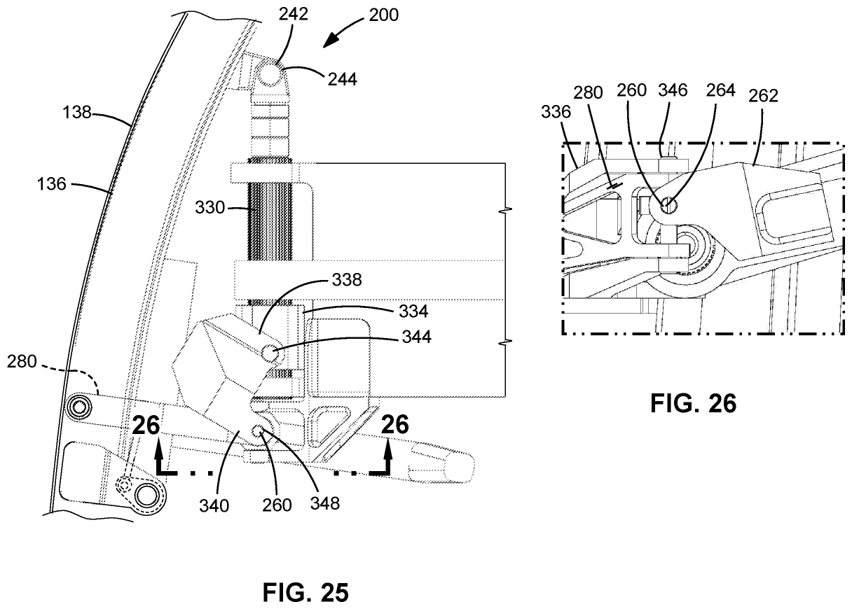

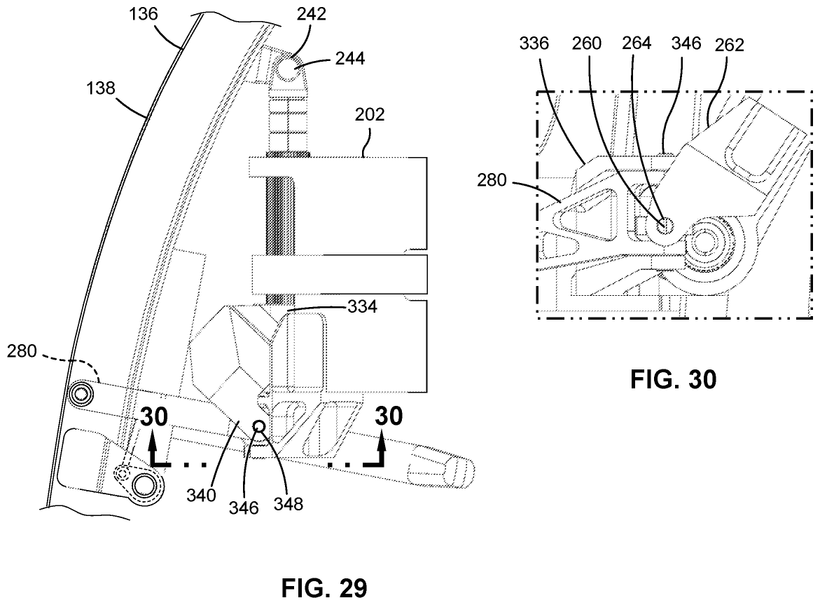

Referring to FIGS. 4-9, shown in FIG. 4 is an outboard-looking perspective view of an example of an emergency egress door 138 in the closed position 132. The emergency egress door 138 is supported by the presently-disclosed door mechanism 200, which is part of a door assembly 130 that includes the above-mentioned escape slide 158 mounted in a stowed configuration 162 within a slide bustle 156 on the inboard 110 (FIG. 6) side of the door lower portion 152. The door assembly 130 includes a door operating handle 142 that is rotatable approximately 180 degrees between a closed orientation 144 and an open orientation 146 (FIG. 15). When the door operating handle 142 is in the closed orientation 144, the emergency egress door 138 is essentially locked in the closed position 132. Moving the door operating handle 142 to the open orientation 146 causes the emergency egress door 138 to move in a generally upward direction to a lifted position 326 (e.g., FIGS. 15-16). Once in the lifted position 326, the emergency egress door 138 can be moved (e.g., manually, via a crew member) in an outboard 112 (FIG. 6) direction toward the open position 134 as shown in FIGS. 17-33 and described in greater detail below.

Although not shown, the door assembly 130 also includes a door mode selector handle (not shown) for arming the emergency egress door 138 when in the closed position 132. The slide upper portion 160 of the escape slide 158 in the stowed configuration 162 has a girt bar (not shown) that engages with the door sill 108 when the door mode selector handle is moved to the armed position. In the event of an emergency, the escape slide 158 will deploy and inflate when the emergency egress door 138 is opened.

Although the presently-disclosed door mechanism 200 is described in the context of an emergency egress door 138 of an aircraft 102, the door mechanism 200 can be implemented on any type of door 136 intended to remain generally parallel to a door opening 106 in a body 100 when the door 136 is translated from a closed position 132 to an open position 134.

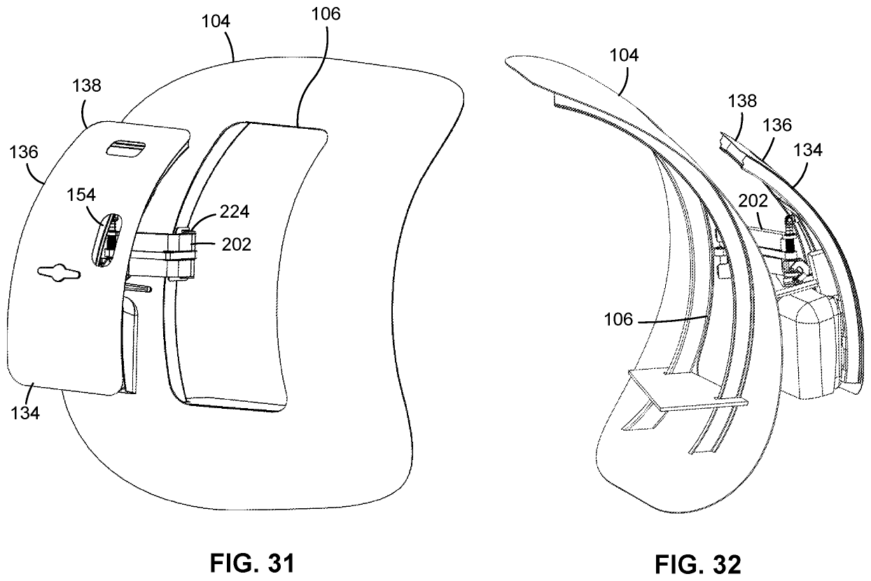

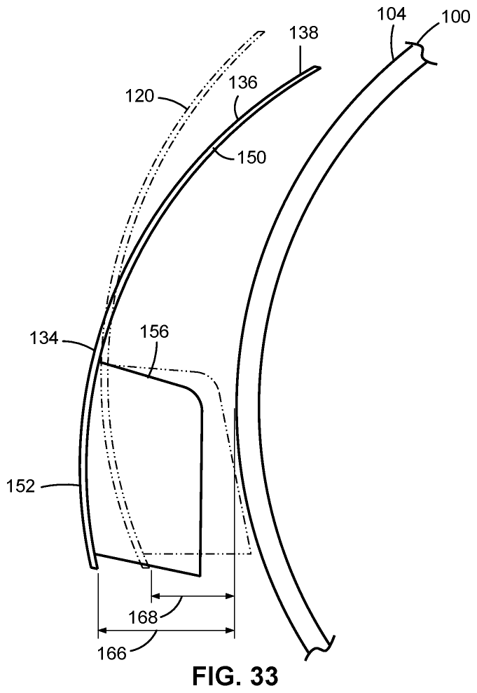

Referring still to FIGS. 4-9, the door mechanism 200 is configured to pivot the emergency egress door 138 in a manner such that during translation of the emergency egress door 138 from the closed position 132 to the open position 134 (FIGS. 31-32), the door lower portion 152 moves in an outboard 112 (FIG. 6) direction to a greater extent than the door upper portion 150. As a result, the emergency egress door 138 in the open position 134 has a tilted orientation relative to its orientation in the closed position 132. As shown in FIG. 33 and described below, the tilted orientation of the emergency egress door 138 results in an increased distance 166 between the door lower portion 152 and the fuselage 104, relative to a nominal distance 168 between the door lower portion 152 and the fuselage 104 of a conventional door 120 supported by a conventional door mechanism (not shown). The increased distance 166 between the door lower portion 152 and the fuselage 104 allows a larger escape slide 158 to be mounted (i.e., within the slide bustle 156) to the door lower portion 152 without the need to increase the length of the arm 202 (FIG. 4) which would undesirably reduce the width of the small window 154 in the emergency egress door 138 and also increase the mass (e.g., weight) of the arm 202.

The increased distance 166 between the door lower portion 152 and the fuselage 104 provides an additional 1-2 cubic feet of volume at the door lower portion 152 for stowing an escape slide 158, as compared to a smaller stowage volume associated with a conventional door 120 supported by a conventional door mechanism (not shown). Advantageously, the increased stowage volume available using the presently-disclosed door mechanism 200 enables stowing larger escape slides 158 such as a wider slide enabling side-by-side egress capability, a larger slide providing life raft capabilities, and/or a longer slide for aircraft that are higher off the ground.

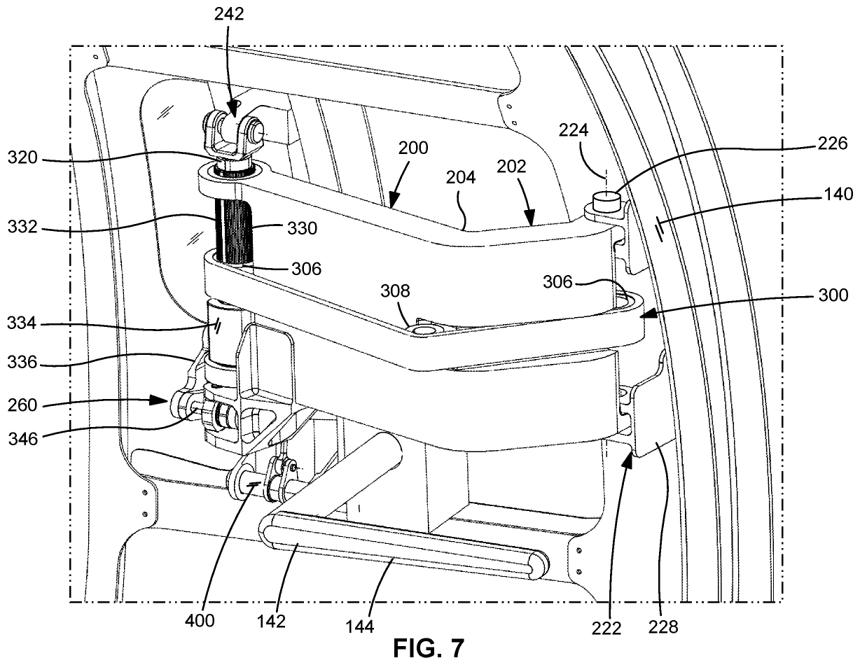

The door mechanism 200 includes the arm 202 which supports the mass of the emergency egress door 138. When viewed from a top-down perspective, the arm 202 has an angled shape (i.e., a bend 204-FIG. 7) that allows the arm 202 to be rotated about an arm-body hinge axis 224 through an angular range such that when the emergency egress door 138 is in the open position 134 (FIGS. 31-32), the emergency egress door 138 is clear of the door opening 106 and also clear of the escape slide 158 (FIG. 3) when deployed.

The arm 202 is coupled to the emergency egress door 138 via an arm-door interface 240 as described in detail below. In addition, the arm 202 is coupled to the side of a door opening 106 in a body 100 (e.g., a fuselage 104 of an aircraft 102) at an arm-body interface 220 (e.g., an arm-fuselage interface). The arm-body interface 220 has an arm-body hinge joint 222 having an arm-body hinge axis 224 (FIG. 7) about which the arm 202 rotates. In the example shown, the arm-body hinge joint 222 comprises an arm-body upper hinge joint 226 and an arm-body lower hinge joint 228. The arm-body upper hinge joint 226 and the arm-body lower hinge joint 228 couple the arm 202 to a body frame 140 that extends along the side of the door opening 106.

As mentioned above, the arm 202 rotates about the arm-body hinge axis 224 (FIG. 7) during translation of the emergency egress door 138 between the closed position 132 and the open position 134 (FIGS. 31-32). In the present example, the arm 202 is configured to rotate through an angle of approximately 135 degrees during translation of the emergency egress door 138 from the closed position 132 to the open position 134. However, the door mechanism 200 can be configured such that translation of the emergency egress door 138 from the closed position 132 to the open position 134 requires rotation of the arm 202 through any angular range, including through an angle of greater than 135 degrees or through an angle of less than 135 degrees.

As mentioned above, the door mechanism 200 includes an arm-door interface 240, which is located on an end of the arm 202 opposite the arm-body interface 220. The arm-door interface 240 couples the arm 202 to the emergency egress door 138 which, as mentioned above, has a door lower portion 152 and a door upper portion 150. The arm-door interface 240 includes an arm-door upper joint 242 and an arm-door lower joint 260. As described in greater detail below and shown in FIG. 14, the arm-door lower joint 260 is located below and inboard 110 (FIG. 6) of the arm-door upper joint 242 when the emergency egress door 138 is in the closed position 132, which causes the arm-door lower joint 260 to pivot about the arm-door upper joint 242 in a manner pivoting the door lower portion 152 in an outboard 112 direction to a greater extent than the door upper portion 150 during translation of the emergency egress door 138 from the closed position 132 to the open position 134 (FIGS. 31-32). As described below, the door mechanism 200 includes a mechanical programming system 300 for maintaining the emergency egress door 138 in generally parallel relation to the door opening 106 (when viewed from a top-down perspective) during translation of the emergency egress door 138 between the closed position 132 and the open position 134.

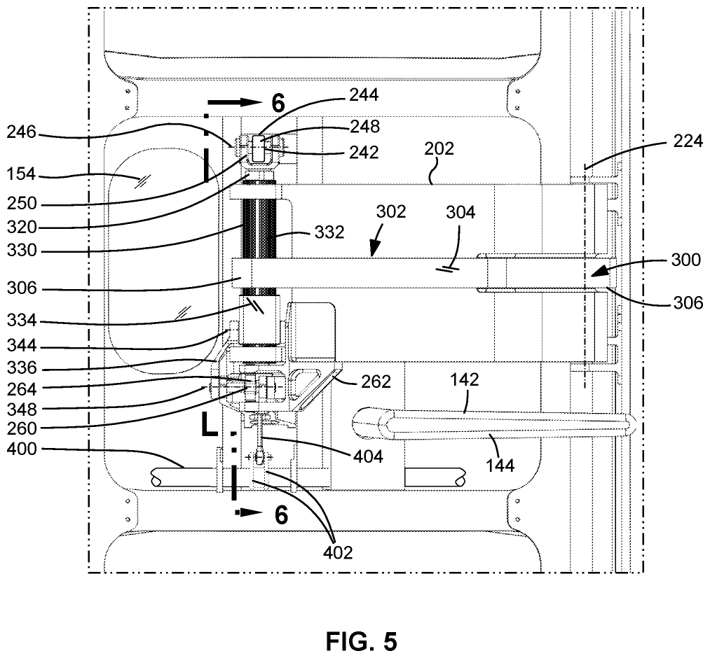

Referring still to FIGS. 4-9, the arm-door upper joint 242 is configured as a spherical joint 244 (e.g., a pivot joint) about which the arm-door lower joint 260 pivots during translation of the emergency egress door 138 between the closed position 132 and the open position 134. In the example shown, the spherical joint 244 is comprised of a ball-socket end fitting 248 (FIG. 5) mounted to the emergency egress door 138. The ball-socket end fitting 248 is coupled to a clevis fitting 250 (FIG. 5) mounted on an upper end of a lift assist mechanism 320. The lift assist mechanism 320 is supported by the arm 202 at the arm-door interface 240. The ball-socket end fitting 248 is rotatable about a spherical joint axis 246 (FIG. 5) that extends through the clevis fitting 250. The ball-socket end fitting 248 accommodates universal rotation of the emergency egress door 138 relative to the arm 202.

The spherical joint 244 may be provided in any one of a variety of alternative configurations and is not limited to the arrangement shown in FIGS. 4-9. For example, the arm-door upper joint 242 can be provided as a ball-socket end fitting 248 mounted on the upper end of the lift column 330, and a clevis fitting 250 coupled to the emergency egress door 138. Other configurations are possible for the arm-door upper joint 242, such as a universal joint or any other joint configuration capable of accommodating substantially universal rotation of the emergency egress door 138 relative to the arm 202.

The arm-door lower joint 260 includes a support fitting 262 (FIG. 5) which protrudes in an aft 116 (FIG. 4) direction from an arm lower portion of the arm 202. In the example shown, the support fitting 262 is coupled to the arm 202 via mechanical fasteners (not shown). However, in other examples, the support fitting 262 can be integrally formed with the arm 202. The arm-door lower joint 260 includes a spherical bearing 264 supported by the support fitting 262 in a manner such that the spherical bearing 264 is rotatable about a spherical bearing vertical axis 266. Notably, the spherical bearing 264 is located inboard 110 of the arm-door upper joint 242 when the emergency egress door 138 is in the closed position 132, as shown in FIG. 14, which causes the emergency egress door 138 to pivot about the spherical bearing 264 in a manner such that the door lower portion 152 moves in an outboard 112 direction to a greater extent than the door upper portion 150 during translation of the emergency egress door 138 from the closed position 132 to the open position 134.

The arm-door lower joint 260 is coupled to the emergency egress door 138 via a connector link 280. As shown in FIGS. 6-9, one end of the connector link 280 is coupled to the emergency egress door 138 at a connector-door joint 282, and an opposite end of the connector link 280 is coupled to a horizontally oriented link shaft 346 that passes through the spherical bearing 264. As shown in FIGS. 14, 18, 22, 26 and 30, the spherical bearing 264 is slidable along the link shaft 346 in a manner accommodating pivoting of the arm-door lower joint 260 about the spherical joint 244 (i.e., the arm-door upper joint 242) during translation of the emergency egress door 138 between the closed position 132 and the open position 134.

As mentioned above, the door mechanism 200 includes a mechanical programming system 300 for maintaining the emergency egress door 138 generally parallel to the door opening 106 during translation of the emergency egress door 138 between the closed position 132 and the open position 134 when viewed from a top-down perspective. The mechanical programming system 300 is configured to cause the emergency egress door 138 to rotate relative to the arm 202 by the same angular amount as the rotation of the arm 202 relative to the door opening 106. Toward this end, the mechanical programming system 300 transmits rotational motion of the arm 202 about the arm-body hinge axis 224 to the emergency egress door 138 for rotation relative to the arm 202 in a manner such that the emergency egress door 138 remains generally (e.g., within 30 degrees) parallel to the door opening 106 during translation of the emergency egress door 138 between the closed position 132 and the open position 134.

In the example shown, the mechanical programming system 300 is a chain-sprocket assembly 302 comprising a chain 304 extending between two sprockets 306. One of the sprockets 306 is fixedly mounted to the arm-body hinge joint 222 at the arm-body interface 220, and the other sprocket 306 is fixedly mounted to a lift column 330 located at the arm-door interface 240. In the example shown, the lift column 330 has external splines 332, and the sprocket 306 has internal grooves (not shown) engaged with the external splines 332 to allow the sprocket 306 to transfer rotational motion of the arm 202 about the arm-body hinge axis 224 to the lift column 330, and ultimately to the emergency egress door 138 via a connector link 280 as described below. Alternatively, the sprocket 306 can be fixedly coupled to the lift column 330 using fasteners (not shown) or the sprocket 306 can be integrally formed with the lift column 330.

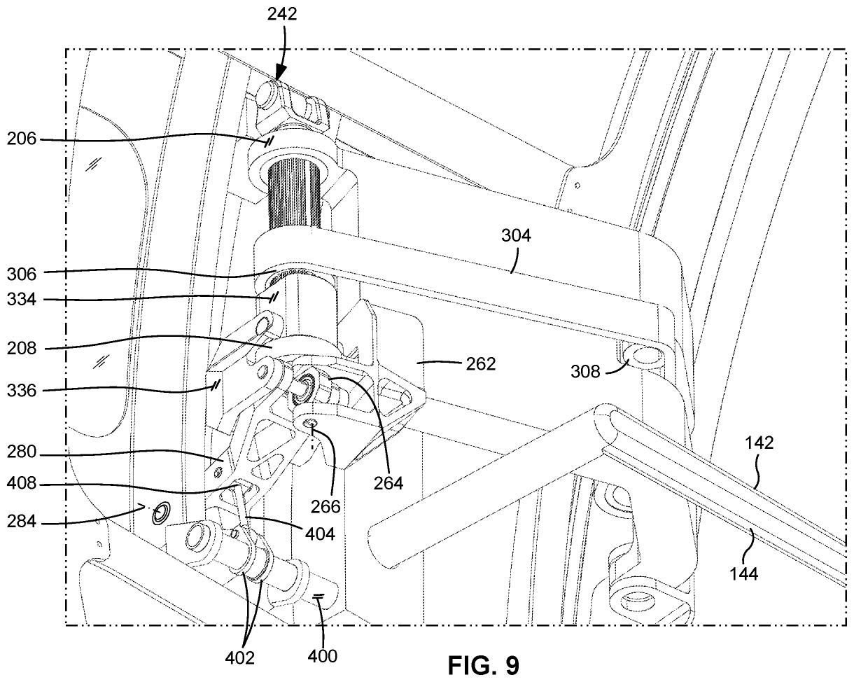

In addition to sprockets 306, the chain-sprocket assembly 302 includes one or more rollers 308 (FIG. 9) and/or tensioners (not shown) mounted to the arm 202. In the example shown, a roller 308 is located on an outboard 112 side of the arm 202 at the location of the bend 204 in the arm 202, and a tensioner (not shown) is located on an inboard 110 side of the arm 202 at the bend 204. The rollers 308 and/or tensioners conform the chain 304 to the angled shape of the arm 202. Although shown and described as a chain-sprocket assembly 302, the mechanical programming system 300 can be provided in any one of a variety of configurations capable of causing the emergency egress door 138 to rotate relative to the arm 202 by the same angular amount as the rotation of the arm 202 relative to the door opening 106. For example, the mechanical programming system 300 can be provided as a rack and pinon arrangement (not shown) or as an arrangement of four-bar mechanisms or links (not shown). Regardless of its specific arrangement, the mechanical programming system 300 is configured to rotate the lift column 330 in a direction opposite to, and in equal magnitude to, the rotation of the arm 202 about the arm-body hinge axis 224.

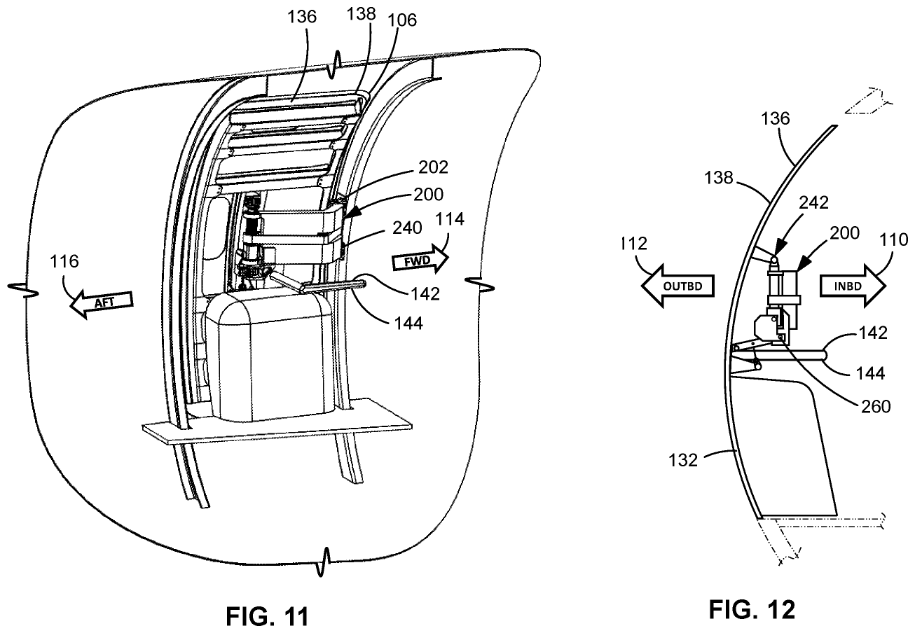

As mentioned above, and referring to FIGS. 4-9, the door mechanism 200 includes a lift assist mechanism 320 configured to assist in lifting the emergency egress door 138 in a vertical direction 118 (FIGS. 15-16) when the emergency egress door 138 is in the closed position 132 and prior to movement of the emergency egress door 138 in the outboard 112 direction toward the open position 134. Vertical lifting of the emergency egress door 138 from the closed position 132 to the lifted position 326 is necessary to release a plurality of door stop assemblies (not shown) vertically distributed along the sides of the emergency egress door 138 and which prevent the emergency egress door 138 in the closed position 132 from moving in an outboard 112 direction when the aircraft 102 cabin (FIGS. 1-2) is internally pressurized. Rotation of the door operating handle 142 from its closed orientation 144 (FIG. 11) to its open orientation 146 (FIG. 15) urges the emergency egress door 138 in a generally upward direction, assisted by the lift assist mechanism 320. More specifically, rotation of the door operating handle 142 causes corresponding rotation of a latch shaft 400 mounted to the emergency egress door 138. Rotation of the latch shaft 400 manipulates latch shaft cranks (not shown) located on the ends of the latch shaft 400. The latch shaft cranks push against guide fittings (not shown) distributed along the sides of the door opening 106, causing the emergency egress door 138 to move upward from the closed position 132 (FIG. 15) to the lifted position 326 (FIG. 15). The direction of movement of the emergency egress door 138 between the closed position 132 and the lifted position 326 is dictated by the guide fittings. For example, the guide fittings are typically configured to guide the emergency egress door 138 a short distance (e.g., less than 0.5 inch) in an inboard-upward direction from the closed position 132 to thereby disengage the door stop assemblies, after which the guide fittings direct the emergency egress door 138 upwardly in the vertical direction 118 (FIGS. 15-16) a distance of approximately two inches into the lifted position 326 under the upward force of the lift assist mechanism 320. In the lifted position 326, the door stop assembly components respectively mounted on the emergency egress door 138 and the door opening 106 will clear each other when the emergency egress door 138 is moved (e.g., manually, via a crew member) in the outboard 112 direction toward the open position 134.

As shown in FIG. 6, the lift assist mechanism 320 is mounted to the arm 202 at the arm-door interface 240. The lift assist mechanism 320 can be a compression spring 322 and/or a linear actuator 324 (e.g., a pneumatic actuator or an electromechanical actuator) mounted within the lift column 330. The lift column 330 is located directly under the arm-door upper joint 242 and is coupled to the arm 202 in a manner allowing the lift column 330 to rotate about its lengthwise axis under rotational force applied by the mechanical programming system 300. For example, the lift column 330 is coupled to the arm 202 via an arm upper flange 206 and an arm lower flange 208, each of which has a bearing or bushing (not shown) rotatably supporting the lift column 330.

The lift assist mechanism 320 has an upper end protruding from the top end of the lift column 330. The upper end of the lift assist mechanism 320 is coupled to the arm-door upper joint 242. For example, as described above, the upper end of the lift assist mechanism 320 has a clevis fitting 250 (FIG. 6) coupled to the ball-socket end fitting 248 (FIG. 6) protruding from the emergency egress door 138. The lift assist mechanism 320 is configured to axially extend in a manner urging the emergency egress door 138 upwardly relative to the arm 202 for moving the emergency egress door 138 from the closed position 132 to the lifted position 326 when the operating handle is rotated from its closed orientation 144 to its open orientation 146.

As mentioned above, the emergency egress door 138 is coupled to the arm lower portion via the connector link 280, one end of which is coupled to the emergency egress door 138, and the opposite end of which is coupled to the spherical bearing 264 at the arm-door lower joint 260. In the example shown, the connector link 280 is coupled to the emergency egress door 138 at a connector-door joint 282. The connector-door joint 282 has a link-door axis 284 about which the connector link 280 rotates during vertical movement (e.g., lifting) of the emergency egress door 138 relative to the arm 202.

The arm-door lower joint 260 includes a torque collar 334 which is non-rotatably mounted on the lift column 330. In addition, the torque collar 334 is axially slidably along the lift column 330. For example, the torque collar 334 includes internal grooves (not shown) configured to mesh with the external splines 332 on the lift column 330. As mentioned above, the mechanical programming system 300 causes the lift column 330 to rotate relative to the arm 202 in a direction opposite to, and in equal magnitude to, the rotation of the arm 202 relative to the door opening 106.

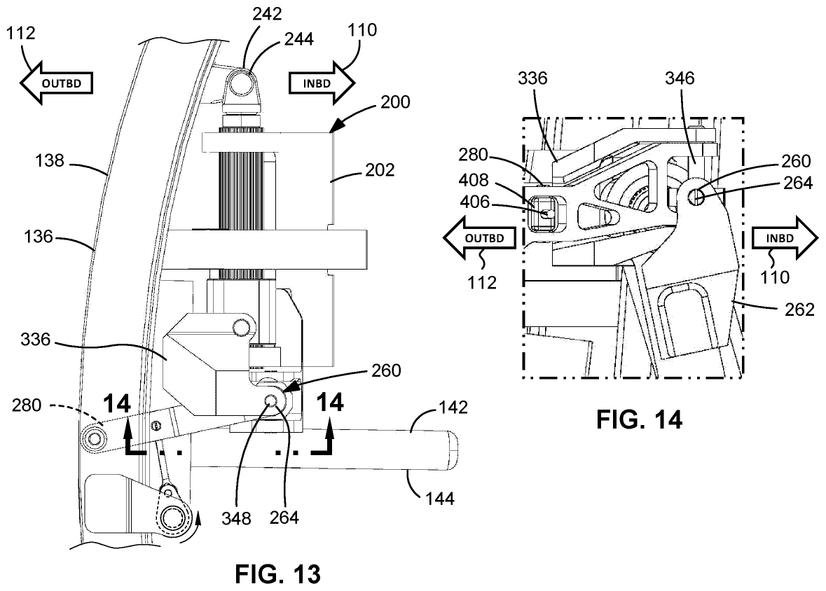

As shown in FIGS. 5-6, the door mechanism 200 further includes a torque link 336 which couples the torque collar 334 to the connector link 280 in a manner transmitting rotational motion of the lift column 330 to the emergency egress door 138 via the connector link 280 to thereby maintain the emergency egress door 138 generally parallel to the door opening 106 during translation of the emergency egress door 138 between the closed position 132 and the open position 134. The torque link 336 has a torque link upper portion 338 coupled to the torque collar 334, and a torque link lower portion 340 coupled to the connector link 280. In the example shown, the torque link upper portion 338 is coupled to the torque collar 334 via a diametrically opposed pair of torque collar pins 342 protruding from opposing sides of the torque collar 334 and which define a horizontally oriented collar-link axis 344. The torque link lower portion 340 is coupled to the connector link 280 at the link shaft 346. The link shaft 346 defines a link-link axis 348 which is parallel to the collar-link axis 344. During vertical movement of the emergency egress door 138 from the closed position 132 (FIGS. 11-14) to the lifted position 326 (FIGS. 15-18), the connector link 280 rotates about the link-link axis 348 at the connector-door joint 282, and the opposite end of the connector link 280 rotates about the link-door axis 284 as shown in FIGS. 13 and 17. During translation of the emergency egress door 138 from the lifted position 326 to the open position 134 (FIGS. 31-32), the torque link lower portion 340 rotates about the link-link axis 348 and the torque link upper portion 338 rotates about the collar-link axis 344 as shown in FIGS. 17, 21, 25 and 29, and which causes the torque collar 334 to axially slide along the lift column 330.

Referring to FIGS. 6-9, the door mechanism 200 includes a lift rod 404 for preventing the emergency egress door 138 from moving downwardly once the emergency egress door 138 is in the lifted position 326. The lift rod 404 extends from the connector link 280 to the latch shaft 400 which is mounted to the emergency egress door 138. As mentioned above, rotation of the door operating handle 142 from its closed orientation 144 to its open orientation 146 (FIG. 15) causes corresponding rotation of the latch shaft 400, which causes the latch shaft cranks (not shown) to push against guide fittings (not shown) distributed along the sides of the door opening 106, causing the emergency egress door 138 to move upward. As the emergency egress door 138 is lifted up to the lifted position 326, the lift rod 404 assumes at least a portion of the weight of the emergency egress door 138 and which prevents the emergency egress door 138 from moving downwardly while the door operating handle 142 is in the open orientation 146, as described below.

The lift rod 404 is coupled to the latch shaft 400 in a manner compensating for changes in the distance between the connector link 280 and the latch shaft 400 during pivoting of the connector link 280 about the link-door axis 284 as a result of the lifting of the emergency egress door 138. For example, the bottom end of the lift rod 404 is captured between a pair of latch shaft tabs 402 extending from one side of the latch shaft 400. The eccentric attachment of the lift rod 404 to the latch shaft 400 maintains the lift rod 404 in tension during pivoting of the connector link 280 as the emergency egress door 138 is translated to the open position 134, thereby allowing the lift rod 404 to support at least a portion of the mass (i.e., the vertical load) of the emergency egress door 138 in addition to support provided by the lift assist mechanism 320. When the door operating handle 142 is in its open orientation 146, the latch shaft 400 is locked against rotation which maintains the lift rod 404 in tension, thereby preventing the emergency egress door 138 in the lifted position 326 from moving downwardly.

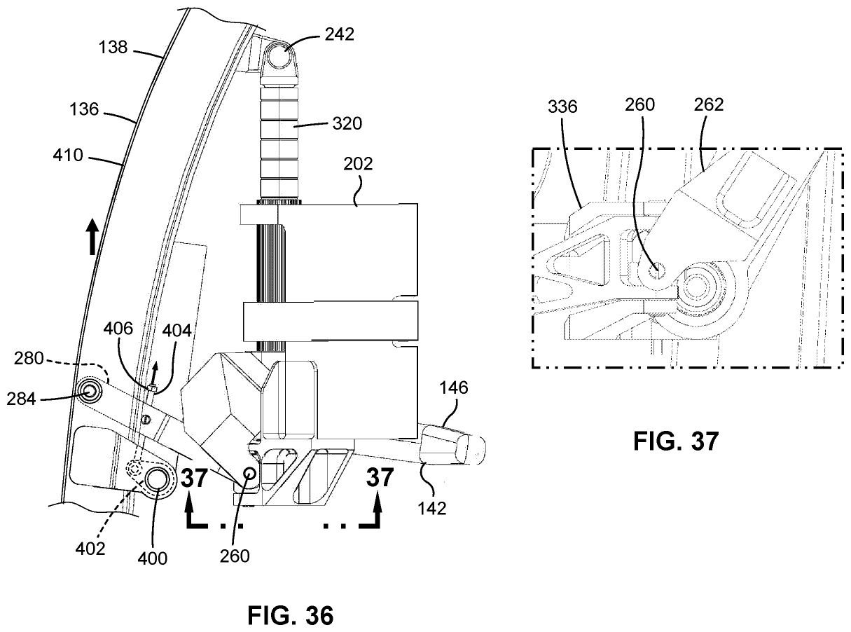

Referring to FIGS. 6-9 and 36, the lift rod 404 has a rod upper end 406 that is configured to move upwardly relative to the connector link 280 in a manner accommodating overlifting of the emergency egress door 138 beyond the lifted position 326 by a force other than the lift assist mechanism 320 when the emergency egress door 138 is in the open position 134. In this regard, the rod upper end 406 is upwardly slidable through a rod bushing 408 (FIG. 9) mounted to the connector link 280. As shown in FIG. 36, the ability of the rod upper end 406 to slide upwardly relative to the connector link 280 accommodates inadvertent or accidental movement of the emergency egress door 138 to an overlifted position 410 (e.g., up to three inches) beyond the vertical distance (e.g., approximately two inches) that the emergency egress door 138 is lifted from its closed position 132 (FIGS. 15-16) by the lift assist mechanism 320.

Movement of the emergency egress door 138 to the overlifted position 410 may occur due to unintentional upward movement of a jetway (not shown) when the jetway is positioned adjacent to an open emergency egress door 138 in preparation for loading or unloading of passengers or cargo (e.g., galley carts). Such unintentional upward movement of the jetway can cause the jetway to contact the emergency egress door 138 and push the emergency egress door 138 upward beyond its lifted position 326 to the overlifted position 410. In another scenario, unintentional downward movement of the fuselage 104 during loading of passengers and/or cargo can cause the emergency egress door 138 to move downwardly and contact the jetway, resulting in an unintended upward force on the emergency egress door 138 relative to the arm 202. Advantageously, the ability of the rod upper end 406 of the lift rod 404 to move upwardly relative to the connector link 280 allows the emergency egress door 138 to freely move upwardly toward the overlifted position 410, thereby reducing the potential for damage to the jetway, the emergency egress door 138, the door mechanism 200, and/or the fuselage 104.

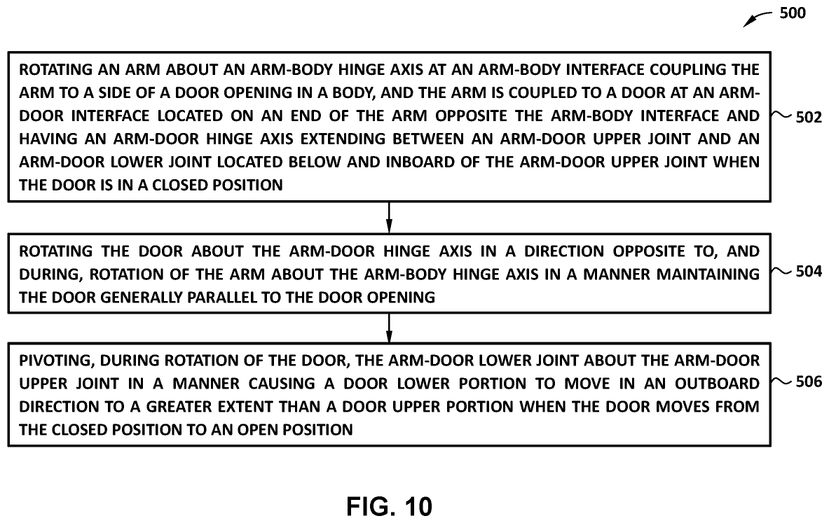

Referring now to the flow chart of FIG. 10 with additional reference to FIGS. 11-37, shown in FIG. 10 is an example of a method 500 of opening an emergency egress door 138 using the presently disclosed door mechanism 200. The method 500 is described in the context of an aircraft 102. As shown in FIGS. 1-3, the aircraft 102 has a fuselage 104 containing a door opening 106, and the door opening 106 has a door sill 108. The emergency egress door 138 has an escape slide 158 mounted in a stowed configuration 162 to an inner side of the door lower portion 152. The escape slide 158 has a slide upper portion 160 that is engageable to the door sill 108 by arming the emergency egress door 138 when in the closed position 132.

FIGS. 11-14 show the emergency egress door 138 in the closed position 132 with the door operating handle 142 in the closed orientation 144. As shown in FIGS. 11-12, the door mechanism 200 has an arm 202 coupling the emergency egress door 138 to the side of the door opening 106. The arm-door interface 240 has an arm-door lower joint 260 located below and inboard 110 of the arm-door upper joint 242 when the emergency egress door 138 is in the closed position 132. FIGS. 13-14 show the spherical bearing 264 of the arm-door lower joint 260 located inboard 110 of the arm-door upper joint 242 (FIG. 13).

Referring to FIGS. 15-18, the method 500 initially includes rotating the door operating handle 142 (e.g., manually, via a crew member) approximately 180 degrees from its closed orientation 144 (FIG. 11) to its open orientation 146 (FIG. 15). As described above, rotating the door operating handle 142 to the open orientation 146 urges the emergency egress door 138 in a generally upward direction, and forces the lift assist mechanism 320 to assist in lifting the emergency egress door 138 from the closed position 132 to the lifted position 326 (FIGS. 15-16) prior to movement of the emergency egress door 138 in the outboard 112 direction toward the open position 134. The step of lifting the emergency egress door 138 using the lift assist mechanism 320 comprises lifting the emergency egress door 138 with assistance from the lift assist mechanism 320 mounted to the side of the arm 202 opposite the arm-body interface 220. As shown in FIG. 17, the lift assist mechanism 320 has an upper end protruding out the lift column 330 and coupled to the arm-door upper joint 242 (e.g., the spherical joint 244). The lift assist mechanism 320 axially extends in a manner moving the arm-door upper joint 242 and thereby assists in moving the emergency egress door 138 upwardly relative to the arm 202.

As described above, the direction of movement of the emergency egress door 138 from the closed position 132 to the lifted position 326 is controlled by the guide fittings (not shown) mounted on opposite sides of the door opening 106. The guide fittings initially direct the emergency egress door 138 a short distance (e.g., less than 0.5 inch) in the inboard-upward direction to disengage the door stop assemblies (not shown) that otherwise prevent the emergency egress door 138 in the closed position 132 from moving in the outboard 112 direction when the aircraft 102 cabin is internally pressurized. After the initial inboard-upward movement of the emergency egress door 138, the guide fittings direct the emergency egress door 138 in an upward direction a distance of approximately two inches into the lifted position 326 under the upward force applied by the lift assist mechanism 320. In the lifted position 326, the emergency egress door 138 is at a height at which the components (e.g., fitting) of the door stop assemblies (not shown) mounted on the side of the emergency egress door 138 and door opening 106 will clear each other when the emergency egress door 138 is moved in the outboard 112 direction toward the open position 134.

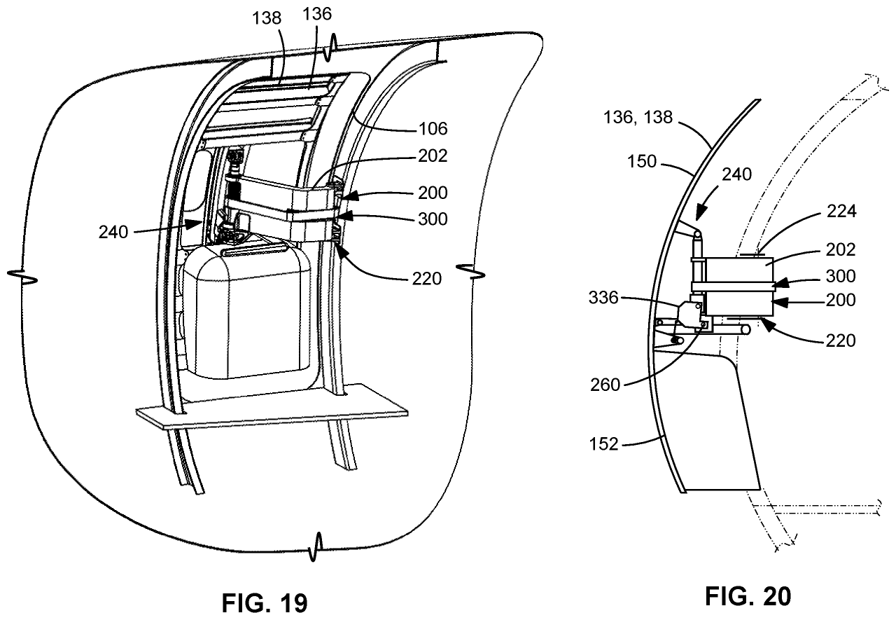

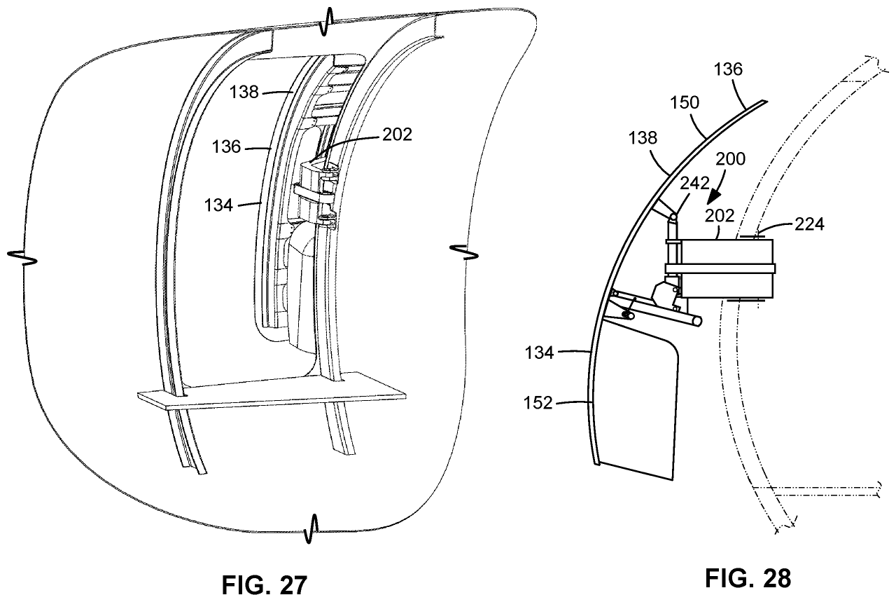

Referring to FIGS. 19-22, step 502 of the method 500 comprises rotating the arm 202 of the door mechanism 200 about the arm-body hinge axis 224 (FIG. 7) at the arm-body interface 220. In this regard, FIGS. 19-20 shown the position of the emergency egress door 138 during the point in the opening sequence at which the arm 202 has been rotated 45 degrees about the arm-body hinge axis 224 from the closed position 132. In the example shown, the emergency egress door 138 moves in a forward 114 direction (FIGS. 3-4) of the aircraft 102 when translating from the closed position 132 (FIG. 15) to the open position 134 (FIG. 27). As described above, the arm-body interface 220 couples the arm 202 to the side of the door opening 106, and the arm 202 is coupled to the emergency egress door 138 at the arm-door interface 240. As shown in FIG. 6, the arm-door hinge axis 268 extends between the arm-door upper joint 242 and the arm-door lower joint 260. When the door operating handle 142 is in its open orientation 146 as shown in FIGS. 15, 19, 23, 27, 31 and 32, the emergency egress door 138 can be manually moved (e.g., pushed open and pulled closed) by a crew member, which causes the arm 202 to rotate about the arm-body hinge axis 224.

Referring still to FIGS. 19-22, step 504 of the method 500 comprises rotating the emergency egress door 138 about the arm-door hinge axis 268 (FIG. 6) in a direction opposite to, and during, rotation of the arm 202 about the arm-body hinge axis 224 in a manner maintaining the emergency egress door 138 generally parallel to the door opening 106. In this regard, the method 500 includes transmitting, using the mechanical programming system 300, rotational motion of the arm 202 about the arm-body hinge axis 224 to the emergency egress door 138 for rotation about the arm-door hinge axis 268 in a direction opposite the rotation of the arm 202, to thereby maintain the emergency egress door 138 parallel to the door opening 106.

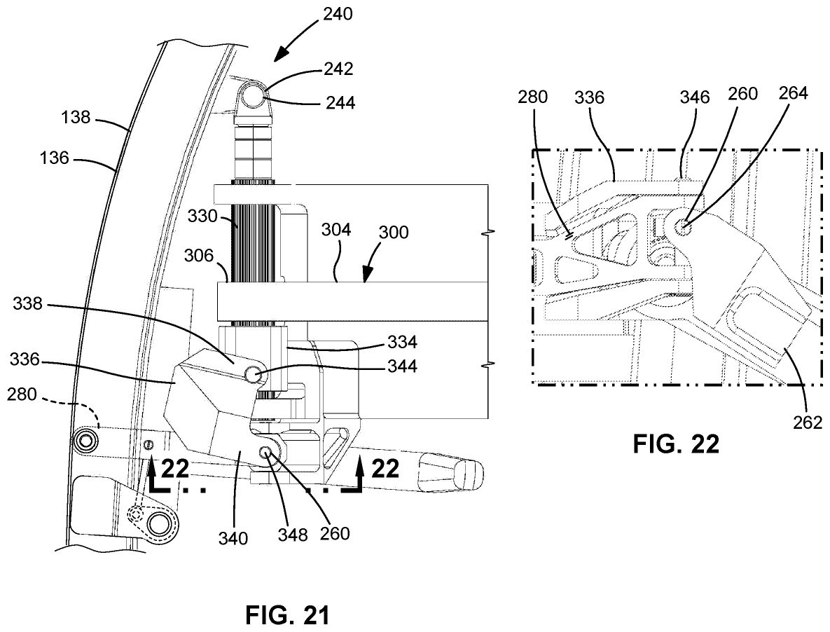

As shown in FIGS. 21-22 and described above, the mechanical programming system 300 is a chain-sprocket assembly 302 having a chain 304 that extends between one sprocket 306 at the arm-body interface 220 (FIG. 19) and one sprocket 306 mounted on the lift column 330 (i.e., at the arm-door interface 240). The step of transmitting rotational motion of the arm 202 to the emergency egress door 138 comprises using the chain 304 to transmit rotational motion of the arm 202 to the lift column 330 which, as a result, rotates in a direction opposite rotation of the arm 202 about the arm-body hinge axis 224. The step of transmitting rotational motion of the arm 202 to the emergency egress door 138 also includes transmitting, using the torque link 336, rotational motion of the lift column 330 to the connector link 280, which extends between the arm lower portion and the emergency egress door 138.

Step 506 of the method 500 comprises pivoting, during rotation of the emergency egress door 138, the arm-door lower joint 260 about the arm-door upper joint 242 in a manner causing the door lower portion 152 (FIG. 20) to move in the outboard 112 direction to a greater extent than the door upper portion 150 when the emergency egress door 138 moves from the closed position 132 to the open position 134, as shown in FIGS. 20, 24, and 28. Step 506 of pivoting the arm-door lower joint 260 about the arm-door upper joint 242 comprises pivoting the arm-door lower joint 260 about the spherical joint 244. In the example shown, the spherical joint 244 is comprised of a ball-socket end fitting 248 (FIGS. 6-9) mounted to the emergency egress door 138, and a clevis fitting 250 (FIGS. 6-9) mounted on the upper end of the lift assist mechanism 320, as described above.

As shown in FIGS. 6-9, the arm-door lower joint 260 comprises the spherical bearing 264 supported by the support fitting 262 protruding from the lower portion of the arm 202. The spherical bearing 264 is located below and inboard 110 of the arm-door upper joint 242. The connector link 280 is coupled at one end to the link shaft 346 which passes through the spherical bearing 264, and the opposite end of the connector link 280 is coupled to the emergency egress door 138. During translation of the emergency egress door 138 between the closed position 132 and the open position 134, the spherical bearing 264 slides along the link shaft 346 (e.g., see FIGS. 14, 18, 22, 26 and 30) in a manner accommodating pivoting of the arm-door lower joint 260 about the spherical joint 244.

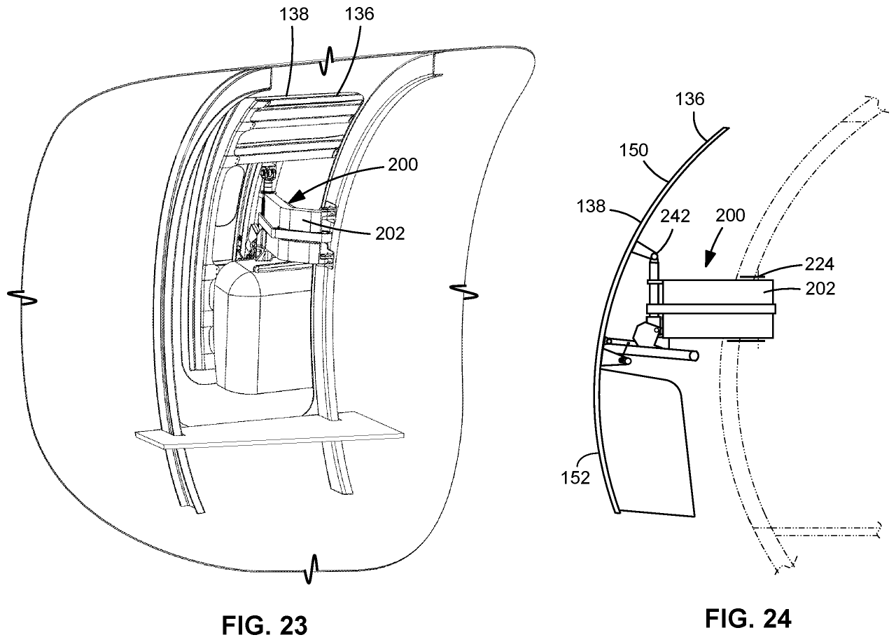

FIG. 23-26 show the position and orientation of the emergency egress door 138 and the door mechanism 200 during the point in the opening sequence at which the arm 202 has been rotated 90 degrees about the arm-body hinge axis 224 during translation of the emergency egress door 138 toward the open position 134. As shown in FIG. 26, the arm-door lower joint 260 (i.e., the spherical bearing 264) has been rotated to a location outboard 112 of the arm-door upper joint 242 (i.e., the spherical joint 244).

FIGS. 27-32 show the position and orientation of the emergency egress door 138 and the door mechanism 200 during the point of the opening sequence where the arm 202 has been rotated 135 degrees about the arm-body hinge axis 224, and which places the emergency egress door 138 in the open position 134. FIG. 30 shows the arm-door lower joint 260 (i.e., the spherical bearing 264) rotated further outboard 112 of the arm-door upper joint 242 (i.e., the spherical joint 244) than in FIG. 26, which increases the tilt angle of the emergency egress door 138.

FIG. 33 is an end view of the emergency egress door 138 in the open position 134 showing its tilted orientation, and the increased distance 166 between the fuselage 104 and the door lower portion 152 of the emergency egress door 138 as supported by the presently-disclosed door mechanism 200, relative to the nominal distance 168 between the fuselage 104 and the door lower portion 152 of a conventional door 120 supported by a conventional door mechanism (not shown). As mentioned above, the increased distance 166 between the door lower portion 152 and the fuselage 104 allows a larger escape slide 158 (e.g., housed within the slide bustle 156) to be mounted to the door lower portion 152 without the need to increase the length of the arm 202, which would undesirably reduce the size (e.g., width) of the window 154 (FIG. 31) in the emergency egress door 138 and/or result in an increase in the mass of the arm 202.

Referring to FIGS. 6-9 and 26, the method 500 includes the step of supporting the emergency egress door 138 in the lifted position 326 using the lift rod 404 which extends downwardly from the connector link 280 and is eccentrically coupled to the latch shaft 400. As described above, the latch shaft 400 is mounted to the emergency egress door 138 and is configured to rotate in response to movement of the door operating handle 142 from the closed orientation 144 to the open orientation 146 during which the lift assist mechanism 320 lifts the emergency egress door 138 from the closed position 132 (FIGS. 11-14) to the lifted position 326 (FIGS. 17-20). As described above, the lift rod 404 is coupled to the latch shaft 400 in a manner such that rotation of the latch shaft 400 places the lift rod 404 in tension as the emergency egress door 138 moves from the closed position 132 to the lifted position 326. In the lifted position 326, the lift rod 404 supports at least a portion of the mass of the emergency egress door 138 in addition to the support provided by the lift assist mechanism 320.

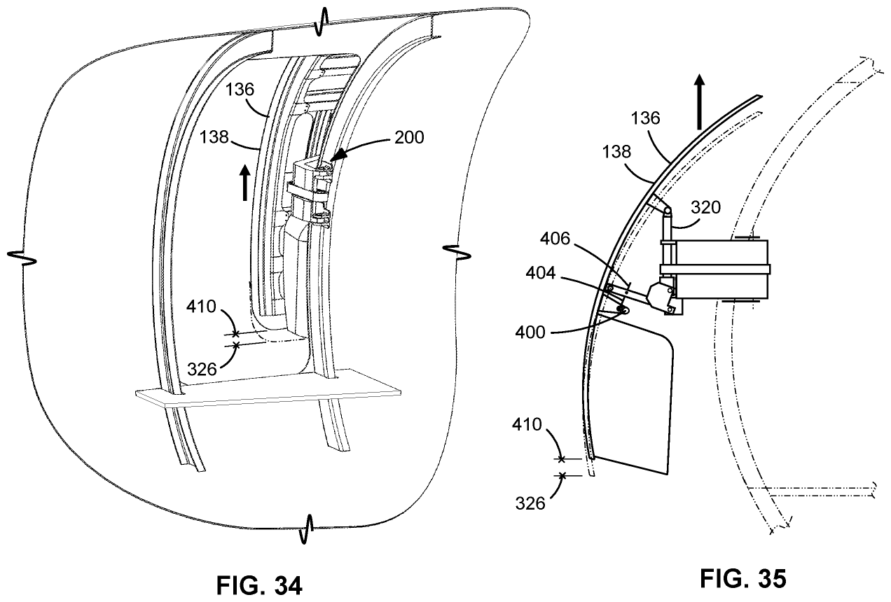

Referring to FIGS. 34-37, the method 500 additionally includes the step of accommodating overlifting of the emergency egress door 138 beyond the lifted position 326 by allowing the rod upper end 406 and print FIG. 36) of the lift rod 404 (FIG. 36) to move freely upwardly relative to the connector link 280 (FIG. 36) when the emergency egress door 138 is moved to an overlifted position 410 (i.e., beyond the lifted position 326) by a force other than the upward force provided by lift assist mechanism 320. FIG. 35 is an end view of the emergency egress door 138 in the open position 134. The emergency egress door 138 is also in the overlifted position 410, which is higher than the lifted position 326 shown in phantom lines. As shown in FIGS. 36, the rod upper end 406 has moved upwardly relative to the connector link 280 in a manner accommodating movement of the emergency egress door 138 to the overlifted position 410. The lift assist mechanism 320 is also configured to extend upwardly during upward movement of the arm-door upper joint 242 (i.e., the emergency egress door 138) to thereby accommodate upward movement of the emergency egress door 138 to the overlifted position 410.

As described above, such upward movement of the emergency egress door 138 to the overlifted position 410 may occur as a result of contact of the emergency egress door 138 with a jetway (not shown) that unintentionally moves upwardly when positioned adjacent to the open emergency egress door 138 for loading or unloading passengers or cargo. Alternatively or additionally, movement of the emergency egress door 138 to the overlifted position 410 may occur duc to unintentional downward movement of the fuselage 104 during loading of passengers and/or cargo, causing the emergency egress door 138 to contact the jetway and resulting in the emergency egress door 138 being urged upwardly relative to the arm 202. Advantageously, the ability of the rod upper end 406 of the lift rod 404 to move upwardly along with the arm-door upper joint 242 (i.e., the spherical joint 244) allows the emergency egress door 138 to move to the overlifted position 410 in a manner preventing damage to the emergency egress door 138, the door mechanism 200, and/or the fuselage 104. In the example shown, the door mechanism 200 is configured to accommodate overlifting of the emergency egress door 138 by approximately three inches beyond the lifted position 326. However, the door mechanism 200 can be configured to accommodate overlifting of the emergency egress door 138 by more than three inches.

Many N modifications and other versions and examples of the disclosure will come to mind to one skilled in the art to which this disclosure pertains having the benefit of the teachings presented in the foregoing descriptions and the associated drawings. The versions and examples described herein are meant to be illustrative and are not intended to be limiting or exhaustive. Although specific terms are employed herein, they are used in a generic and descriptive sense only and not for purposes of limitation. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled.

What is claimed is:

1. A door mechanism, comprising:
an arm configured to be coupled to a side of a door opening in a body at an arm-body interface having an arm-body hinge axis about which the arm rotates;
an arm-door interface located on an end of the arm opposite the arm-body interface and configured to couple the arm to a door having a door lower portion and a door upper portion, the arm-door interface comprising:
an arm-door upper joint; and
an arm-door lower joint located below and inboard of the arm-door upper joint when the door is in a closed position, and configured to pivot about the arm-door upper joint in a manner pivoting the door lower portion in an outboard direction to a greater extent than the door upper portion during translation of the door from the closed position to an open position.

2. The door mechanism of claim 1, wherein:
the arm-door upper joint is configured as a spherical joint;
the arm-door lower joint comprises:
a support fitting protruding from the arm and having a spherical bearing located below and inboard of the arm-door upper joint; and
a connector link having one end couplable to the door, and an opposite end is couplable to the spherical bearing in a manner accommodating pivoting of the arm-door lower joint about the spherical joint during translation of the door between the closed position and the open position.

3. The door mechanism of claim 1, further comprising:
a mechanical programming system configured to transmit rotational motion of the arm about the arm-body hinge axis to the door for rotation relative to the arm in a manner such that the door remains generally parallel to the door opening during translation of the door between the closed position and the open position.

4. The door mechanism of claim 1, further comprising:
a lift assist mechanism configured to assist in lifting the door when the door is in the closed position and prior to movement of the door in the outboard direction toward the open position.

5. The door mechanism of claim 4, wherein:
the lift assist mechanism is mounted to a side of the arm opposite the arm-body interface and has an upper end couplable to the arm-door upper joint and configured to axially extend in a manner moving the door upwardly relative to the arm.

6. The door mechanism of claim 5, further comprising:
a connector link configured to couple the door to an arm lower portion of the arm;
a lift column configured to house the lift assist mechanism and rotate in a direction opposite the rotation of the arm about the arm-body hinge axis;
a torque collar non-rotatably mountable on the lift column; and
a torque link configured to couple the torque collar to the connector link in a manner transmitting rotational motion of the lift column to the door via the connector link to thereby maintain the door generally parallel to the door opening during translation of the door between the closed position and the open position.

7. The door mechanism of claim 6, further comprising:
a horizontally-oriented latch shaft rotatably mounted to the door;
a lift rod extendable downwardly from the connector link and eccentrically couplable to the latch shaft; and
wherein the door has a door operating handle configured to be rotated from a closed orientation to an open orientation during which the lift assist mechanism is configured to assist in vertically lifting the door to a lifted position, and the door operating handle in the open orientation is configured to lock the latch shaft against rotation to thereby prevent the door in the lifted position from moving downwardly.

8. The door mechanism of claim 7, wherein:
the lift rod has a rod upper end configured to move upwardly relative to the connector link in a manner accommodating overlifting of the door beyond the lifted position by a force other than the lift assist mechanism.

9. The door mechanism of claim 1, wherein:
the arm-body interface comprises an arm-body upper hinge joint and an arm-body lower hinge joint located below the arm-body upper hinge joint.

10. An aircraft, comprising:
a fuselage having a door opening, and an emergency egress door having a door lower portion and a door upper portion;
a door mechanism coupling the emergency egress door to the fuselage, and comprising:
an arm coupled to a side of the door opening at an arm-body interface having an arm-body hinge axis about which the arm rotates;
an arm-door interface located on an end of the arm opposite the arm-body interface and coupling the arm to the emergency egress door, the arm-door interface comprising:
an arm-door upper joint; and
an arm-door lower joint located below and inboard of the arm-door upper joint when the emergency egress door is in a closed position, and configured to pivot about the arm-door upper joint in a manner pivoting the door lower portion in an outboard direction to a greater extent than the door upper portion during translation of the emergency egress door from the closed position to an open position.

11. The aircraft of claim 10, wherein:
the door opening has a door sill; and
the emergency egress door includes an inflatable escape slide mounted in a stowed configuration to an inner side of the door lower portion and having a slide upper portion that is engageable to the door sill by arming the emergency egress door when in the closed position.

12. A method of opening a door, comprising:
rotating an arm about an arm-body hinge axis at an arm-body interface coupling the arm to a side of a door opening in a body, and the arm is coupled to a door at an arm-door interface located on an end of the arm opposite the arm-body interface and having an arm-door hinge axis extending between an arm-door upper joint and an arm-door lower joint located below and inboard of the arm-door upper joint when the door is in a closed position;
rotating the door about the arm-door hinge axis in a direction opposite to, and during, rotation of the arm about the arm-body hinge axis in a manner maintaining the door generally parallel to the door opening; and
pivoting, during rotation of the door, the arm-door lower joint about the arm-door upper joint in a manner causing a door lower portion to move in an outboard direction to a greater extent than a door upper portion when the door moves from the closed position to an open position.

13. The method of claim 12, wherein pivoting the arm-door lower joint about the arm-door upper joint comprises:
pivoting the arm-door lower joint about a spherical joint, and the arm-door lower joint comprises:
a support fitting protruding from the arm and having a spherical bearing located below and inboard of the arm-door upper joint; and
a connector link coupled at one end to the door, and an opposite end of the connector link is coupled to the spherical bearing.

14. The method of claim 12, further comprising:
transmitting, using a mechanical programming system, rotational motion of the arm about the arm-body hinge axis to the door for rotation about the arm-door hinge axis in a direction opposite the rotation of the arm, to thereby manner maintain the door generally parallel to the door opening during translation of the door between the closed position and the open position.

15. The method of claim 12, further comprising:
rotating a door operating handle from a closed orientation to an open orientation to thereby lift the door from the closed position to a lifted position prior to moving the door in the outboard direction toward the open position.

16. The method of claim 15, further comprising:
assisting in lifting the door using a lift assist mechanism mounted to a side of the arm opposite the arm-body interface and having an upper end coupled to the arm-door upper joint and which axially extends in a manner moving the door upwardly relative to the arm.

17. The method of claim 16, wherein transmitting rotational motion of the arm to the door comprises:
transmitting rotational motion of the arm to a lift column housing the lift assist mechanism and which rotates in a direction opposite rotation of the arm about the arm-body hinge axis; and
transmitting, using a torque link, rotational motion of the lift column to a connector link extending between the door and an arm lower portion of the arm.

18. The method of claim 17, further comprising:
supporting the door in the lifted position using a lift rod extending downwardly from the connector link and eccentrically coupled to a horizontally-oriented latch shaft mounted to the door and configured to rotate in coordination with movement of a door operating handle from a closed orientation to an open orientation in a manner maintaining the lift rod in tension.

19. The method of claim 18, wherein:
accommodating overlifting of the door beyond the lifted position by allowing a rod upper end of the lift rod to move freely upwardly relative to the connector link when the door is moved upwardly beyond the lifted position by a force other than the lift assist mechanism.

20. The method of claim 12, wherein:
the door is an emergency egress door of an aircraft having a fuselage containing the door opening, and the door opening has a door sill; and
the emergency egress door includes an inflatable escape slide mounted in a stowed configuration to an inner side of the emergency egress door and having a slide upper portion that is engageable to the door sill by arming the emergency egress door when in the closed position.
